(19) United States
(12) Patent Application Publication
(10) Pub. No.: US 2017/0076339 A1
(43) Pub. Date: Mar. 16, 2017

(54) Method, Apparatus, Computer Program Product and System for Reputation Generation

(71) Applicant: Nokia Technologies Oy, Espoo (FI)

(72) Inventor: Zheng Yan, Xi'an, Shaanxi (CN)

(73) Assignee: Nokia Technologies Oy, Espoo (FI)

(21) Appl. No.: 15/312,125

(22) PCT Filed: Jun. 12, 2014
(86) PCT No.: PCT/CN2014/079701

§ 371 Date: Nov. 17, 2016

(51) Int. Cl. G06Q 30/02; G06F 7/02

(52) U.S. Cl. CPC G06Q 30/0282; G06F 7/026; G06F 2216/03

(57) ABSTRACT

Method, apparatus, system, computer program product and computer readable medium are disclosed for generating reputation of an entity from a plurality of opinions associated with that entity, wherein the entity and the plurality of opinions are expressed in a natural language. The method comprises filtering said plurality of opinions based on pertinence of each opinion with respect to the entity; fusing the filtered opinions into at least one principle opinion set; and generating a reputation value based on said at least one principle opinion set. The method further comprises providing reputation visualization for users, and recommending an entity based on its reputation value, opinions provided by users, opinion pertinence and user opinion's similarity.

### FIELD OF THE INVENTION

Embodiments of the disclosure generally relate to information technologies, and, more particularly, to computer-based data mining and fusing.

### BACKGROUND

The fast growth of the network has dramatically changed the way that people express their opinions. Nowadays, people can freely post their views, feedback, comments and attitudes on any entities (e.g., products, hotels, services etc.) through numerous networked applications, such as websites or platforms etc., to express their personal opinions. They can also freely share their attitudes and comments in online and mobile social networking. As opinions express subjective attitudes, evaluations, and speculations of people in natural languages; this kind of contents contributed by the networked users has been well recognized as valuable information. It can be exploited to analyze public opinions on a specific object (e.g., topic or product) in order to figure out user preference.

Extracting reputation information of an entity is important for making a wise decision. However, no existing solutions can generate reputation through mining and fusing opinions expressed in natural languages, as well as opinion voting, opinion citation and user feedback rating in a comprehensive way. Further, it lacks a comprehensive visualization of reputation to effectively assist users in decision making. Therefore, it is desirable to provide an improved technical solution for reputation generation.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one aspect of the disclosure, it is provided a method for generating reputation of an entity from a plurality of opinions associated with that entity, wherein the entity and the plurality of opinions are expressed in a natural language. The method comprises: filtering said plurality of opinions based on pertinence of each opinion with respect to the entity; fusing the filtered opinions into at least one principle opinion set; and generating a reputation value based on said at least one principle opinion set.

According to another aspect of the present disclosure, it is provided a computer program product embodied on a distribution medium readable by a computer and comprising program instructions which, when loaded into a computer, execute the above-described method.

According to still another aspect of the present disclosure, it is provided a non-transitory computer readable medium having encoded thereon statements and instructions to cause a processor to execute the above-described method.

According to still another aspect of the present disclosure, it is provided an apparatus for generating reputation of an entity from a plurality of opinions associated with that entity, wherein the entity and the plurality of opinions are expressed in a natural language. The apparatus comprises: a filter configured to filter said plurality of opinions based on pertinence of each opinion with respect to the entity; a fuser configured to fuse the filtered opinions into at least one principle opinion set; and a reputation generator configured to generate a reputation value based on said at least one principle opinion set.

According to still another aspect of the present disclosure, it is provided a system comprising the above described apparatus and opinion data configured to store information about a plurality of opinions associated with an entity.

These and other objects, features and advantages of the disclosure will become apparent from the following detailed description of illustrative embodiments thereof, which is to be read in connection with the accompanying drawings.

### BRIEF DESCRIPTION OF THE DRAWINGS

FIG. 1 is a simplified block diagram illustrating a system according to an embodiment;

FIG. 2 is a simplified block diagram illustrating a system according to another embodiment;

FIG. 3 is a simplified block diagram illustrating a system according to still another embodiment;

FIG. 4 is a simplified block diagram illustrating a system according to still another embodiment;

FIG. 5 is a simplified block diagram illustrating a system according to still another embodiment;

FIG. 6 is a flow chart depicting a process of reputation generation according to an embodiment;

FIG. 7 is a flow chart depicting a process of reputation generation and visualization according to an embodiment;

FIG. 8 is a flow chart depicting a process of recommendation according to an embodiment;

FIG. 9 shows an example of reputation visualization according to an embodiment.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

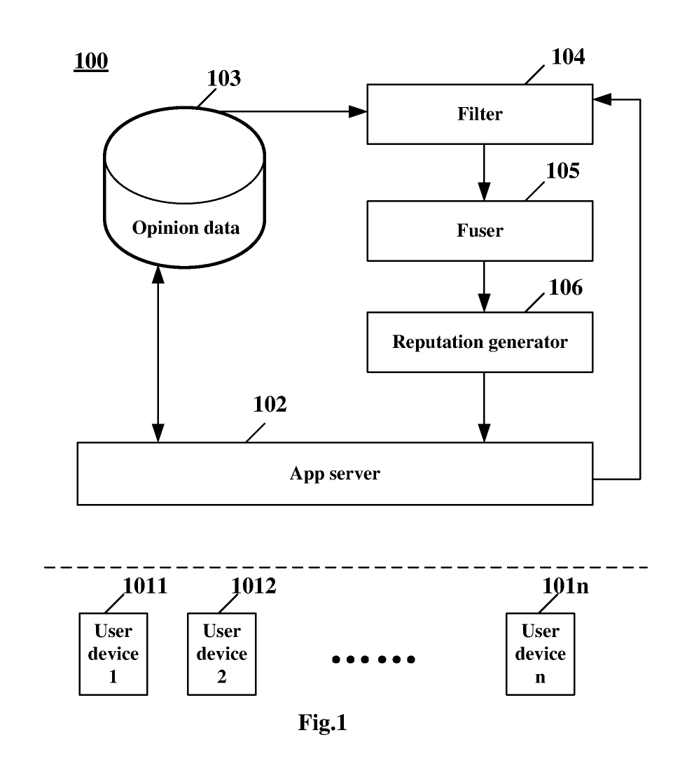

As described herein, an aspect of the disclosure includes providing a technical solution for generating reputation of an entity from a plurality of opinions associated with that entity. FIG. 1 shows a system 100 in which some embodiments of this disclosure can be implemented.

As shown in FIG. 1, the system 100 comprises a plurality of user devices 1011-101n each operably connected to an application server 102. The user devices 1011-101n can be any kind of user equipment or computing devices including, but not limited to, smart phones, tablets, laptops, servers, thin clients, set-top boxes and PCs, running with any kind of operating system including, but not limited to, Windows, Linux, UNIX, Android, iOS and their variants. For example, the user devices 1011-101n can be Windows phones, having an app installed in it, with which the users can access the service provided by the application server 102. The service can be any kind of service including, but not limited to, news service such as Nokia Xpress Now, NBC News, social networking service such as LinkedIn, Facebook, Twitter, YouTube, messaging service such as WeChat, Yahoo! Mail, and on-line shopping service such as Amazon, Alibaba, TaoBao etc. The users can also access the service with web browsers, such as Internet Explorer, Chrome and Firefox, or other suitable applications installed in the user devices 1011-101n. In this case, the application server 102 would be a web server.

A user can post his opinions expressed in a nature language with respect to an entity. The term “opinion” here generally refers to an expression of any length made by a user, including but not limited to, comments, reviews, criticisms, preferences, feedback, statements, declarations, and assertions. The term “entity” here generally refers to an item made available to a user, including but not limited to, products, hotels, restaurants, services, works of music or art, literary works such as news, articles, stories, books, and reports. Further, a user can rate an entity, for example, from “0” to “5” with “0” for the least preferable and “5” for the most preferable. Moreover, a second user can vote or cite an opinion of the first user. For example, the second user could vote up or vote down (e.g. like or dislike) the first user's opinions and, express his own opinions on the entity as well. The application server 102 can store and retrieve the opinions associated with an entity in opinion data 103, and provide opinions about the entity to a user who is viewing the entity for example.

Opinion data 103 have information about entities available to the users and opinions associated with each entity, which can be used by the application server 102 and other components of the system 100. The entities and opinions are expressed in a natural language, such as English or Chinese. For example, when an entity is a literary work, its expression can be the work itself; when an entity is a product or service, its expression can be a description of the entity. The opinion data 103 can be stored in a centralized or distributed database, such as, RDBMS, SQL, NoSQL, etc., or as one or more files on any storage medium, such as, HDD, diskette, CD, DVD, Blue-ray Disc, EEPROM, SSD, etc. The opinion data 103 can be acquired from the application server 102 or from another connected element such as another application server, website, platform, storage device etc., and they can be automatically or manually updated in real time or over a period of time. It is noted that the embodiments described in this disclosure are not limited to a specific kind of service, a specific implementation of the service, a specific kind of entity, or a specific natural language.

The system 100 comprises a filter 104 configured to filter the opinions based on pertinence of each opinion with respect to the entity it is associated with. As mentioned above, the users can post their opinions expressed in a nature language, and a user can freely vote or cite other's opinions. Some irresponsible or even malicious users may input advertisement information, spams or irrelevant statements under an entity, or maliciously inflate or deflate an entity. Thus, the filter 104 aims to filter out opinions that are not related to their associated entities or that have less pertinence or relevance with respect to their associated entities.

According to an embodiment, the filter 104 can use opinion pertinence to measure the relevance of an opinion to its associated entity. By way of example, the opinion pertinence can be denoted as a normalized value such as between [0, 1] that indicates the probability the opinion can be generated from the entity based on their similarity and correlation. Thus, this pertinence value can distinguish the degree of relevance, rather than simply classify opinions as spam or non-spam used in some exiting technologies.

In this embodiment, the filter 104 calculates the pertinence of each opinion based on similarity between the opinion and the entity, and correlation among the plurality of opinions associated with the entity. The similarity is calculated with vector space model (VSM) taking into consideration at least one of the factors including importance of a term in the expression and semantic similarity between terms. VSM is well known in the art as an algebraic model for representing text documents (and any objects, in general) as vectors of identifiers, such as, index terms. In this embodiment, an opinion or entity is expressed in a nature language, which can be represented by VSM. For example, the expression D of an entity or opinion can be viewed as a point in a multi-dimensional vector space, denoted as (t₁, w₁; t₂, w₂; . . . ; tₘ, wₘ). Herein tᵢ represents the term i appearing in D, and wᵢ represents the times of term tᵢ appearing in D, used to evaluate the importance of the term tᵢ in D.

For example, the similarity between an opinion r and its associated entity A can be computed with VSM as follows:

$$Sim ( r , A ) = \frac{{\sum }_{i}^{n} c ( {w}_{i} , r ) c ( {w}_{i} , A )}{\sqrt{{\sum }_{i}^{n} {c ( {w}_{i} , r )}^{2}} \sqrt{{\sum }_{i}^{n} {c ( {w}_{i} , A )}^{2}}} \qquad ( 1 )$$

where function c(w, r) represents the times of term w appearing in r, c(w, A) represents the times of term w appearing in A. c(w, r) and c(w, A) are the weights of terms w in the vector representations of opinion r and entity A, respectively.

Unlike the traditional VSM, in this embodiment the filter 104 also takes into consideration the importance of a term in the expression (e.g., weight) and semantic similarity between terms to calculate the similarity. For example, the weight of term w in entity A can be adjusted based on its importance in the entity. The terms that distributed widely in A and/or appear in the title or in the first/last sentence of a paragraph are probably the key terms of the expression. Thus, in this embodiment, the filter 104 can calculate the weight of term w in A with the following Formula 2:

Weight(w,A)=c(w,A)*M*Pos(w)+1, (2)

where Weight(w, A) denotes the weight of term w in A, c(w, A) represents the times of term w appearing in A, M denotes the number of paragraphs which contain term w. The value of Pos(w) is set depending on the position of w. In this embodiment, the filter 104 uses a data smoothing method by adding “1” at the end of Formula (2) to avoid zero probability.

According to this embodiment, the filter 104 also takes into consideration the semantic similarity between terms. In natural languages, many semantically similar concepts may be expressed with different words or phrases. It is likely that different terms may be used in the expressions of an entity and its associated opinions. Thus direct comparison using term-based VSM may be compromised. The filter 104 can utilize any existing or future semantic similarity technologies to discover semantically similar terms. For example, details of semantic similarity measurement are described by Y. Neuman et al., in the article entitled “Fusing distributional and experiential information for measuring semantic relatedness” (Information Fusion, 14(3) (2012), 281-287), which is incorporated here in its entirety by reference. Another example is HowNet (www.keenage.com), which is an authoritative ontology for nature languages (e.g., Chinese and English). In HowNet, each word links to several concepts, and each concept is represented by several primitive expressions separated by commas. Details of quantifying semantic similarity are disclosed by Y. Guan et al., in the article entitled “Quantifying semantic similarity of Chinese words from HowNet” (Proceedings of the International Conference on Machine Learning and Cybernetics (2002) 234-239), which is incorporated in its entirety by reference.

In this embodiment, the similarity between two terms is defined as the maximum similarity of their corresponding concepts, and the similarity of two concepts can be calculated based on the similarities of their primitive expressions. Thus, the following formula can be used:

Semantic(w₁,w₂=max Semantic(c₁ᵢ,c₂ⱼ) (3)

where Semantic(w1, w2) is the semantic similarity measure of the terms w₁ and w₂, c₁ᵢ is the concept of w₁, and c₂ⱼ is the concept of w₂.

From the above, the final formula to calculate the similarity between an opinion r and its associated entity A can be obtained as follows:

$$Sim ( r , A ) = \frac{{\sum }_{i}^{n} {\sum }_{j}^{n} c ( {w}_{i} , r ) Weight ( {w}_{j} , A ) Semantic ( {w}_{i} , {w}_{j} )}{\sqrt{{\sum }_{i}^{n} {c ( {w}_{i} , r )}^{2}} \sqrt{{\sum }_{i}^{n} {c ( {w}_{i} , A )}^{2}}} \qquad ( 4 )$$

As shown above, this embodiment utilizes an improved VSM taking two new factors into consideration: the importance of a term in A and the semantic similarity between terms. In this way, this embodiment can provide more accurate similarity calculation than traditional VSM.

Furthermore, in this embodiment, the filter 104 calculates the pertinence of each opinion based on not only similarity between the opinion and the entity, but also correlation among the opinions. By way of example, where an opinion r is similar to another opinion that has a high degree of relevance to the entity, then the opinion r should be also relevant to the entity, even though it does not have a high degree of similarity with the entity.

According to this embodiment, the correlation between two opinions can be represented as the cosine similarity of them. On the basis of the cosine similarities between opinions, an undirected graph of opinions is constructed. In the graph, each node represents an opinion; its value denotes the opinion's pertinence to the entity; the weight of the edge between two nodes denotes the cosine similarity of the two corresponding opinions. If the similarity between two opinions is not zero, the corresponding nodes are connected as neighbors with each other in the graph. In light of this graph, the fuser 105 can calculate an opinion rᵢ's pertinence Per(rᵢ′, A) contributed by the correlation among opinions based on suitable algorithms such as the Random Walk algorithm, for example, with the following weighting scheme:

$$Per ( {r}_{i} , A ) = {\sum }_{{r}_{j} ∈ adj [ {r}_{i} ]} \frac{w ( {r}_{j} , {r}_{i} )}{{\sum }_{{r}_{k} ∈ adj [ {r}_{j} ]} w ( {r}_{j} , {r}_{k} )} Per ( {r}_{j} , A ) \qquad ( 5 )$$

where adⱼ[rᵢ] denotes the opinions that are neighbors of rᵢ. w(rⱼ, rᵢ) is the cosine similarity between rⱼ and rᵢ. It is noted that while w(rⱼ, rᵢ) refers to the cosine similarity between rⱼ and rᵢ in this embodiment, Formula 4 and other algorithms can also be used to calculate the similarity between rⱼ and rᵢ. Formula 4 may achieve better results in certain circumstances because as described above it takes into consideration importance of terms and terms' semantic similarity.

In an embodiment, the filter 104 can integrate the two measures, namely, similarity between an opinion and its associated entity, and correlation between opinions. As an example, the filter 104 can use an integrated formula as below:

$$Pertinence ( {r}_{i} , A ) = d \times \frac{Sim ( r , A )}{{\sum }_{r ∈ R} Sim ( r , A )} + ( 1 - d ) [ {\sum }_{{r}_{j} ∈ adj [ {r}_{i} ]} \frac{w ( {r}_{j} , {r}_{i} )}{{\sum }_{k ∈ adj [ j ]} w ( {r}_{j} , {r}_{k} )} Pertinence ( {r}_{j} , A ) \qquad ( 6 )$$

where rᵢ is an opinion on entity A, R is the set of all opinions on A, Sim(rᵢ, A) denotes the normalized similarity between rᵢ and A based on formula (4). Pertinence(rᵢ, A) denotes the degree of the relevance of rᵢ to A. Parameter d represents a damping coefficient, which controls the trade-off between the two items in the formula. It is noted that d can be set to different values in different circumstances. According to an embodiment, d is set to d=0.7. adj[rᵢ] and w(rⱼ, rᵢ) have the same meanings as in formula (5).

The detailed process of calculating the final pertinence according to an embodiment is described in the following Algorithm 1. Here, the output is defined as a vector pₖ, which denotes the stationary pertinence values of all opinions after kₜₕ iteration. Threshold ε, which is a predefined value, is used to control the termination of iteration. ∥pₖ−pₖ₋₁∥ denotes the difference between pₖ and pₖ₋₁. If ∥pₖ−pₖ₋₁∥ is smaller than the threshold ε, then the iteration will be terminated automatically.

Algorithm 1. Stationary Opinion Pertinence Computation

Input:
Sim(r₁, A),Sim(r₂, A), ......, Sim(rₙ, A): the similarity between opinions
and the entity A;
w(rᵢ, rⱼ), 1≦i, j≦n: the cosine similarity among opinions;
ε: the threshold to control the termination of iteration.
Output: vectorpₖ: the stationary pertinence values of all opinions.

| | |
|---|---|
| (1) | set p₀ with a random vector; |
| (2) | k=0; |
| (3) | repeat |

| | |
|---|---|
| (4) | k=k+1 |

| | |
|---|---|
| (5) | calculate the pertinence value of each opinion using formula (6); |

(6) form vector pₖ with the above pertinence values;

| | |
|---|---|
| (7) | δ=\| \|pₖ−pₖ₋₁\| \|; |

| | |
|---|---|
| (8) | untilδ<ε |
| (9) | returnpₖ |

After calculating the pertinence of each opinion, the filter 104 can filter out an opinion whose pertinence is less than a first threshold. The first threshold can be differently defined in different contexts. For example, if the number of opinions associated with a target entity is very large, then the first threshold can be defined relatively large to exclude as many less-relevant opinions as possible. By contrast, if only a small number of opinions are associated with a target entity, then the first threshold can be defined relatively small to include as many opinions as possible. In another embodiment, the first threshold can be determined through machine learning based on training or historical data. Further, the first threshold can be modified or updated after a period of time or when one or more predefined conditions are satisfied. In addition, the first threshold is configured in order to balance between computation efficiency and the accuracy of opinion filtering.

As shown in FIG. 1, the system 100 further comprises a fuser 105 configured to fuse the filtered opinions into at least one principle opinion set. The principle opinion set is defined as a set of similar opinions. In determining similarity between opinions, the fuser 105 can utilize any existing techniques, such as formula (1), or improved techniques, such as formula (4).

In an embodiment, the fuser 105 is further configured to set similarity between two opinions to a certain value based on the relationship between the two opinions. As mentioned above, a second user can vote up or vote down (e.g. like or dislike) an existing opinion of a first user, or cite an old opinion in a new opinion.

In this embodiment, the similarity between a positive voting opinion and its voted opinion is set to “1”; while the similarity between a negative voting opinion and its voted opinion is set to “0”. For citing opinions, the similarity between a positive citing opinion and its cited opinion is set to c (0.5<c<=1), while the similarity between a negative citing opinion and its cited opinion is set to 1-c.

After obtaining the similarities between the opinions, the fuser 105 can subsequently fuse certain opinions into a principle opinion set if the similarities between those opinions are greater than a second threshold.

According to an embodiment, the fuser 105 can use the following opinion fusion algorithm:

Algorithm 2. Opinion Fusion

Input:
R={r₁, r₂, ......, rₙ}: the opinion set about the entity A after filtering;
F={f₁, f₂, ......, fₙ}: the fusing flags of opinions;
Sim(rᵢ, rⱼ), 1≦i, j≦n: the similarity among opinions;
Sₖ: the sum of the similarity in a principal opinion set k;
Nₖ: the number of similar opinions in a principal opinion set k;
Vₖ: the sum of ratings on the entity A in a principal opinion set k;
tₒ: the threshold to control opinion fusion.
Output: principal opinions and their popularity values.
(1) k=1, fᵢ=0 (1≦i≦n), Sₖ=0, Nₖ=0, Vₖ=0

| | |
|---|---|
| (2) | For i=1; i<=n; i++, Do |

| | |
|---|---|
| (3) | For j=i; j<=n; j++, Do |

(4) if Sim(rᵢ, rⱼ)>tₒ&&fⱼ==0
(5)Fuse rⱼ with rᵢ by adding them into Rₖ if Rₖ hasn't contained them

| | |
|---|---|
| (6) | fⱼ=1; Sₖ=Sₖ+Sim(rᵢ, rⱼ); Nₖ++; Vₖ= Vₖ+Vⱼ |

| | |
|---|---|
| (7) | if Rₖis not empty, k=k+1;Sₖ=0; Nₖ=0; Vₖ=0 |

(8)

| | |
|---|---|
| (9) | returnRₖ, Sₖ, Vₖ, Nₖ |

As shown above, in addition to fusing, the algorithm 2 also returns the following outputs: the sum of the similarity in each principal opinion set Sₖ, the number of similar opinions in each principal opinion set Nₖ, the sum of ratings on the entity A in each principal opinion set Vₖ. It is assumed that each opinion has a rating on the associated entity. However, this may not be true for every opinion.

According to an embodiment, the system 100 can further comprise a first rater (not shown) configured to generate a rating for an opinion which provides no rating on the associated entity. For example, the average rating of other opinions in the same principle opinion set can be used for the non-rating opinion. When all opinions in a principle opinion set fail to provide any rating on the associated entity, the first rater can generate a rating for each opinion, by utilizing any existing or future rating generation techniques. For example, details of rating generation have been disclosed by C. W. Leung, et al., in the article entitled “A probabilistic rating inference framework for mining user preferences from reviews” (World Wide Web 14 (2011) 187-215), which is incorporated in its entirety by reference.

As shown in FIG. 1, the system 100 further comprise a reputation generator 106 configured to generate a reputation value for the entity based on the at least one principle opinion set associated with it. In an embodiment, the reputation generator 106 can generate the reputation value as follows:

$$Re p ( A ) = ( {\sum }_{k = 1}^{K} \frac{θ ( {N}_{k} ) \cdot {V}_{k} \cdot {S}_{k}}{{N}_{k} \cdot {N}_{k}} ) / k \qquad ( 7 )$$

Here, the Rayleigh cumulative distribution function θ(N)=1−e^{-N}^{²}^{/2σ}^{²} is applied to model the impact of an integer number N, where σ>0, is a parameter that inversely controls how fast the number N impacts the increase of θ(N). As shown in Formula (7) the Rayleigh cumulative distribution function is used to model the popularity of a principal opinion, tailored by its opinion set average similarity Sₖ/Nₖ and the average rating value Vₖ/Nₖ. It is noted that Formula (7) is just an exemplary formula and that those skilled in the art will be able to contemplate other suitable formula by using at least some or all results of the fuser 105.

In an embodiment, the reputation generator 106 can store the reputation value and related information (such as the fusing results and outputs of the fuser 105) for an entity in the opinion data 103. For example, the fusing results may include: the sum of the similarity in each principal opinion set, the number of similar opinions in each principal opinion set, the sum of ratings on the entity in each principal opinion set, the distribution of similarities of all principal opinion sets, the distribution of opinions of all principal opinion sets, the distribution of ratings of all principal opinion sets, etc. In this way, if a user device such as user device 1011 or application server 102 requests the reputation value and related information of the entity, the system can directly retrieve them therefrom. Thus, it can save time and computation resources. Meanwhile, it is possible for the server to offer corresponding services to provide requested aggregated information and thus play as a (cloud) service provider of opinion mining.

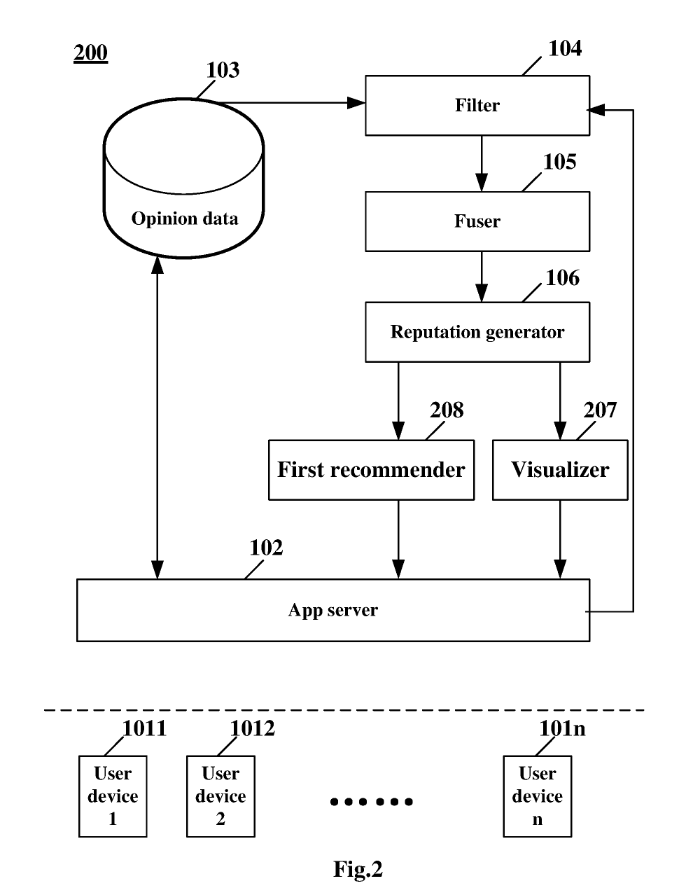

FIG. 2 is a simplified block diagram illustrating a system 200 according to another embodiment. The system 200 comprises a plurality of user devices 1011-101n, an application server 102, an opinion data 103, a filter 104, a fuser 105, and a reputation generator 106. Similar components are denoted with similar numbers in FIGS. 1 and 2. For brevity, the description of similar components is omitted here.

As shown in FIG. 2, the system 200 further comprises a first recommender 108 configured to recommend an entity based on its reputation value. According to an embedment, there are multiple entities and their associated opinions in the opinion data 103, the reputation generator 106 generates a reputation value for each entity as described above. The first recommender 108 can then rank the entities according to their reputation values and recommend the entities with the highest reputation values, for example, top 10 entities.

As shown in FIG. 2, the system 200 further comprises a visualizer 107 configured to provide reputation visualization for a user. According to an embodiment, the visualizer 107 can present to a user with sufficient information in order to assist in his decision making. For example, it can show the top principal opinions and their popularity, average similarity of a principal opinion, and the average rating of the principal opinion, as well as the normalized reputation value.

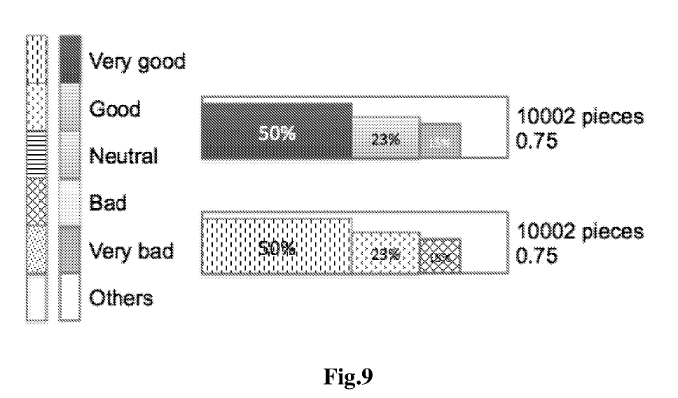

FIG. 9 depicts an example of reputation visualization according to an embodiment. In this example, for each entity the top three principal opinions with highest popularities are shown as rectangle bars. The length (width) of each bar indicates the popularity (percentage of people holding similar opinions), the color or style of the bar indicates the average rating of the principle opinion set. Different colors or styles can be used to indicate opinion types or categories, e.g., very good, good, neutral, bad, very bad, etc. The bar's height shows the opinion similarity of the principle opinion set. The full scale is 1. The bars are connected. At the end of bars, it shows the total number of the filtered opinions used for reputation generation and the normalized reputation value. Alternatively, the reputation values can be displayed in other forms, such as, number of stars. It is noted that FIG. 9 is only an illustrative example and those skilled in the art will be able to contemplate other ways to present the reputation and related information. In this embodiment, the reputation visualization is intended to provide a sufficient view on major opinions mined from the filtered opinion data.

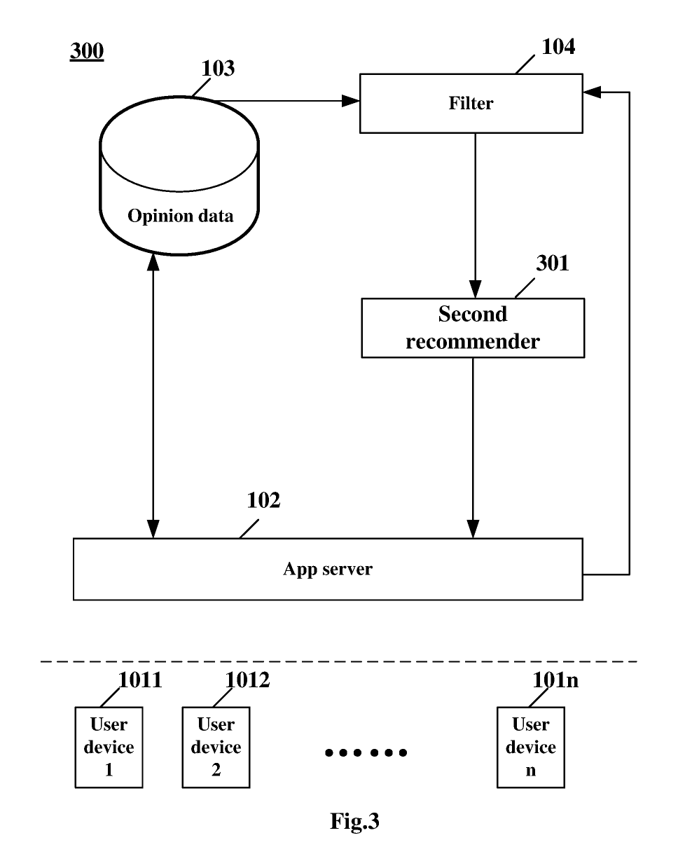

FIG. 3 is a simplified block diagram illustrating a system 300 according to still another embodiment. The system 300 comprises a plurality of user devices 1011-101n, an application server 102, an opinion data 103, and a filter 104. Similar components are denoted with similar numbers in FIGS. 1 to 3. For brevity, the description of similar components is omitted here.

As shown in FIG. 3, the system 300 further comprises a second recommender 301 configured to calculate an estimated rating of a user on a candidate entity, which the user has not commented, based on ratings of other users and existing opinions of that user and the other users, and recommend the entity based on the estimated rating. It is understood that similar users have similar preferences. Thus, it is possible to predict a user's rating on a candidate entity, even the user has not provided his opinion or rating on the candidate entity, or even the user has not seen that entity. This can be done by examining activities of other users who have similar tastes or preferences.

In an embodiment, the second recommender 301 can calculate an estimated rating of a user on a candidate entity as follows:

$${V}_{0 , p} = \frac{{\sum }_{i = 1}^{n} {\sum }_{j = 1}^{m} Sim ( {r}_{o , j} , {r}_{i , j} ) \cdot {V}_{i , p}}{{\sum }_{i = 1}^{n} {\sum }_{j = 1}^{m} Sim ( {r}_{o , j} , {r}_{i , j} )} , ( Sim ( {r}_{o , j} , {r}_{i , j} ) > {t}_{0} ; p ∈ P ) \qquad ( 8 )$$

Here, it is assumed that a user u₀ holds opinions {r_{0,1}, r_{0,2}, r_{0,3}, . . . , r_{0,m}} on a number of entities AA={A₁, . . . , Aₘ}; a number of other users u₁, . . . , uₙ also provide opinions on not only the entities in AA, but also other entities Ap(pεP) that are not commented by u₀. r_{i,j} denotes the opinion provided by uᵢ on Aⱼ, V_{i,p} denotes the rating of uᵢ on Aₚ. Sim(r_{0,j}, r_{i,j}) denotes the similarity between an opinion of the user u₀ and an opinion of a similar user uᵢ with respect to the same entity Aⱼ. The similarity can be calculated by using existing techniques, such as formula (1), or improved techniques, such as formula (4), as described above. t₀ is a threshold, which can be a predefined value or determined by the context, and is used to exclude some users that are not very similar to the user u₀. V_{0,p} denotes the estimated ratings of u₀ on Aₚ.

After calculating the estimated ratings, the second recommender 301 recommends one or more entities based on the estimated ratings. For example, if there are multiple entities in Aₚ, the second recommender 301 can rank the entities according to their estimated ratings and recommend the entities with the highest estimated ratings, for example, top 10 entities.

Similar to the embodiments described above, before calculating the estimated ratings, the filter 103 can filter the opinion data to exclude irrelevant opinions or spams. In this way, the accuracy of estimation for recommendation can be improved.

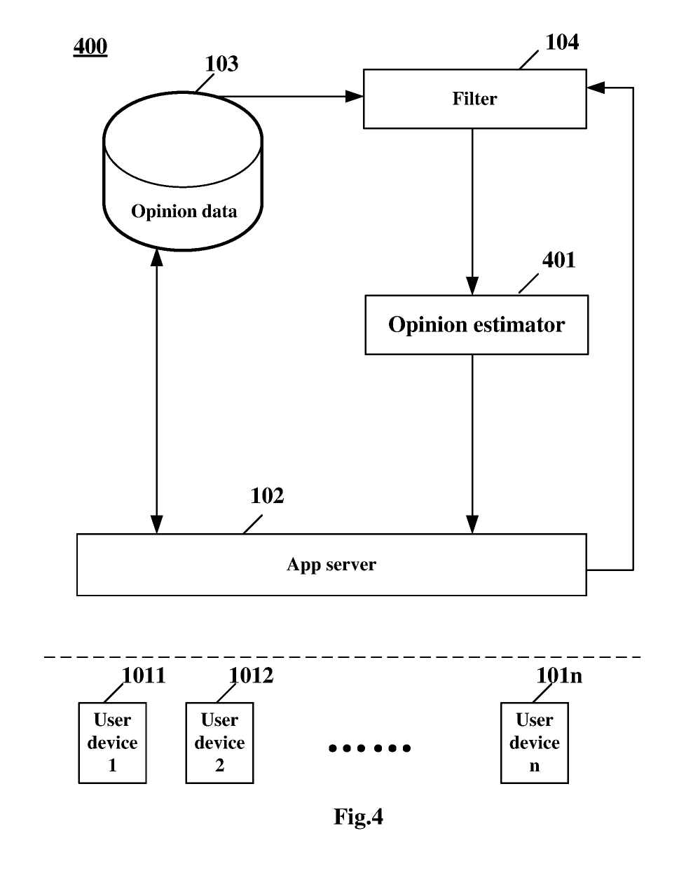

FIG. 4 is a simplified block diagram illustrating a system 400 according to still another embodiment. The system 400 comprises a plurality of user devices 1011-101n, an application server 102, an opinion data 103, and a filter 104. Similar components are denoted with similar numbers in FIGS. 1 to 4. For brevity, the description of similar components is omitted here.

As shown in FIG. 4, the system 400 further comprises an opinion estimator 401 configured to generate an estimated opinion of a user on a candidate entity, which the user has not commented, based on existing opinions of that user and other users. As explained above, similar users have similar preferences. It is possible to predict a user's opinion on a candidate entity, even the user has not commented the candidate entity, or even the user has not seen that entity. This can be done by examining activities of other users who have similar tastes or preferences.

In an embodiment, the opinion estimator 401 can generate an estimated opinion of a user on a candidate entity as follows:

$${r}_{0 , p} = {⋃}_{i = 1}^{n} \frac{{\sum }_{j = 1}^{m} Sim ( {r}_{0 , j} , {r}_{i , j} )}{m} {r}_{i , p} , ( Sim ( {r}_{0 , j} , {r}_{i , j} ) > {t}_{0} ; p ∈ P ) \qquad ( 9 )$$

Here, it is assumed that a user u₀ holds opinions {r_{0,1}, r_{0,2}, r_{0,3}, . . . , r_{0,m}} on a number of entities AA={A₁, . . . , Aₘ}, a number of other users u₁, . . . , uₙ also provide opinions on not only the entities in AA, but also other entities Ap(pεP) that are not commented by u₀. r_{i,j} denotes the opinion provided by uᵢ on Aⱼ, Sim(r_{0,j}, r_{i,j}) denotes the similarity between an opinion of the user u₀ and an opinion of user uᵢ with respect to the same entity Aⱼ. The similarity can be calculated by using existing techniques, such as formula (1), or improved techniques, such as formula (4), as described above. t₀ is a threshold, which can be a predefined value or can be determined according to the context, and is used to exclude those users who do not share similar opinions as the user u₀. r_{0,p} denotes the estimated opinions of u₀ with respect to Aₚ.

Similar to the embodiments described above, before calculating the estimated opinion, the filter 103 can filter the opinion data to exclude irrelevant opinions or spams. In this way, the accuracy of estimation can be improved.

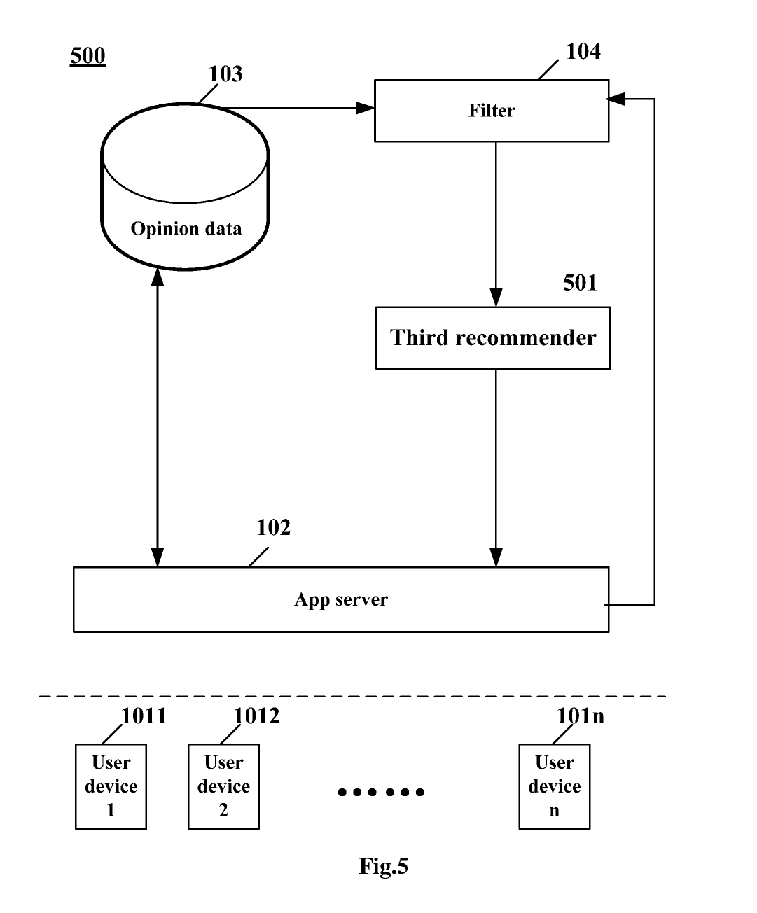

FIG. 5 is a simplified block diagram illustrating a system 500 according to still another embodiment. The system 500 comprises a plurality of user devices 1011-101n, an application server 102, an opinion data 103, and a filter 104. Similar components are denoted with similar numbers in FIGS. 1 to 5. For brevity, the description of similar components is omitted here.

As shown in FIG. 5, the system 500 further comprises a third recommender 501 configured recommend an entity, which a user has not commented, based on the sentiment of other users similar to the user on the entity. As explained above, similar users have similar preferences. It is possible to predict a user's preference on a candidate entity, even the user has not commented the candidate entity, or even the user has not seen that entity. This can be done by examining activities of other users who have similar tastes or preferences.

In this embodiment, it is assumed that a user u₀ holds opinions {r_{0,1}, r_{0,2}, r_{0,3}, . . . , r_{0,m}} on a number of entities AA={A₁, . . . , Aₘ}, a number of other users u₁, . . . , uₙ also provide opinions on not only the entities in AA, but also other entities Ap(pεP) that are not commented by the user u₀. The third recommender 501 can calculate the similarities between the user u₀ and other users u₁, . . . , uₙ as follows:

Σⱼ₌₁^{m}Sim(r_{0,j},r_{i,j}) (10)

Here, r_{0,j} the opinion provided by the user u₀ on Aⱼ, and r_{i,j} denotes the opinion provided by another user uᵢ on Aⱼ (i=1 . . . n). Sim(r_{0,j},r_{i,j}) denotes the similarity between the two opinions, namely, an opinion of the user u₀ and an opinion of a similar user uᵢ with respect to the same entity Aⱼ. The similarity can be calculated by using existing techniques, such as formula (1), or improved techniques, such as formula (4), as described above. For each of the users u₁, . . . , uₙ, the third recommender 501 sums all opinion similarities between the user uᵢ and the user u₀. The sum is used as a measure of the similarity between the user uᵢ and the user u₀. The third recommender 501 then ranks the users uᵢ, . . . , uₙ according to their similarities with respect to the user u₀. Thus, the third recommender 501 can find out the most similar user or users. Finally the third recommender 501 can recommend one or more entities, which the user u₀ has not commented, based on the sentiment of the most similar user(s). For example, the third recommender 501 can recommend to the user u₀ an entity that is “liked” or “disliked” by the most similar user(s).

It will be appreciated that the above-described embodiments and their components can be combined in various manners. For example, the first recommender 208, the second recommender 301, the opinion estimator 401, the third recommender 501 or any of their combinations can be incorporated into the embodiments illustrated in FIGS. 1 and 2. The fuser 105, the reputation generator 106 and/or visualizer 207 can also be incorporated into the embodiments illustrated in FIGS. 3 to 5.

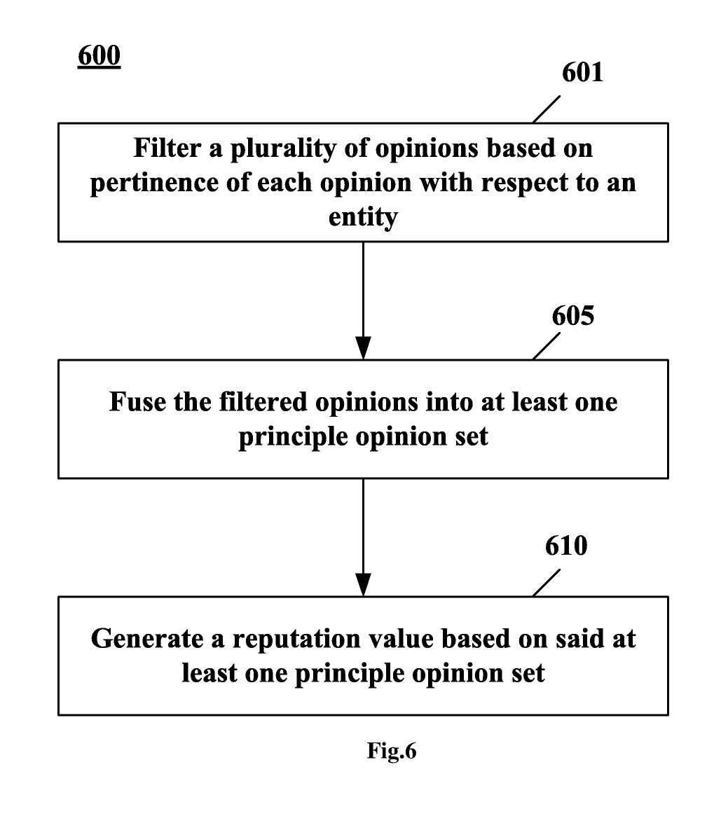

FIG. 6 is a flow chart depicting a process 600 of reputation generation according to an embodiment. As shown in the figure, the process 600 starts at step 601 where a plurality of opinions are filtered based on pertinence of each opinion with respect to its associated entity. As described above with other embodiments, at step 601, the system calculates the pertinence of each opinion based on similarity between the opinion and the entity, and correlation among a plurality of opinions. Further, in the computation of similarity and correlation, vector space model (VSM) can be used by taking into consideration at least one of the factors including importance of a term in the expression and semantic similarity between terms. After obtaining the pertinence value of each opinion, a first threshold can be used to filter out those opinions whose pertinence values are less than the first threshold.

After filtering, the process proceeds to step 605 where the filtered opinions are further fused into at least one principle opinion set. As described above with other embodiments, at step 605, the system calculates similarities between the filtered opinions. Similar opinions are fused into a principle opinion set if the similarities between them are greater than a second threshold. Similar to the above-described embodiments, the similarities can be calculated by using existing techniques, such as formula (1), or improved techniques, such as formula (4). For example, the system can use vector space model taking into consideration at least one of the factors including importance of a term in the expression and semantic similarity between terms, as described above.

Moreover, where two opinions have a voting relationship, i.e. one opinion voting the other opinion, then the similarity between the two opinions can be set to a certain value. For example, the similarity between a positive voting opinion and its voted opinion can be set to “1”; while the similarity between a negative voting opinion and its voted opinion can be set to “0”. Further where two opinions have a citing relationship, i.e. one opinion citing the other opinion, then the similarity between the two opinions is set to another value. For example, the similarity between a positive citing opinion and its cited opinion can be set to c (0.5<c<=1), while the similarity between a negative citing opinion and its cited opinion can be set to 1-c.

After fusing, the process proceeds to step 610 where a reputation value is generated for the entity based on the at least one principle opinion set. As described above, in generating the reputation value, multiple factors can be considered, such as, the number of opinions in each principle opinion set, its opinion set average similarity and its average rating value.

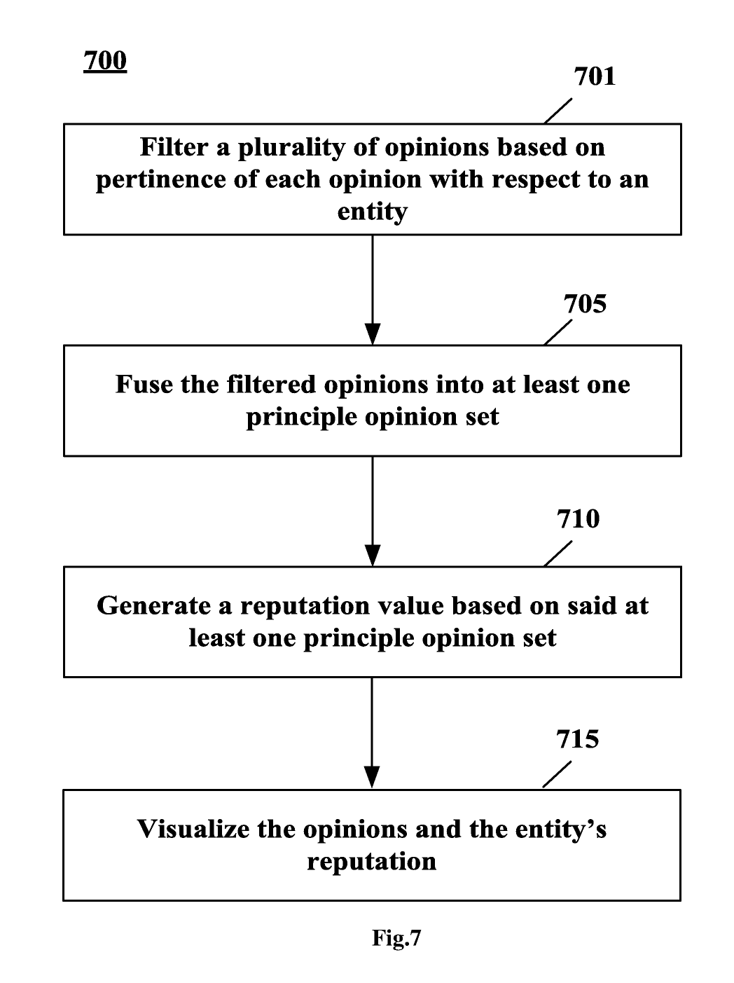

FIG. 7 is a flow chart depicting a process 700 of reputation generation and visualization according to an embodiment. The steps 701, 705, and 710 in this embodiment are similar to the 601, 605, and 610 in FIG. 6 respectively. For brevity the description of these steps is omitted here. As shown in FIG. 7, after generating the reputation value for the entity at step 710, the process proceeds to step 715 where the opinions and the entity's reputation are visualized by reference to the at least one principle opinion set. As described above, FIG. 9 shows an example of reputation visualization. For each entity the top three principal opinions with highest popularities are shown as rectangle bars. The bars are connected. At the end of bars, it shows the total number of filtered opinions used for reputation generation and the normalized reputation value. Again, FIG. 9 is only an illustrative example and those skilled in the art will be able to contemplate other ways to present the reputation and related information.

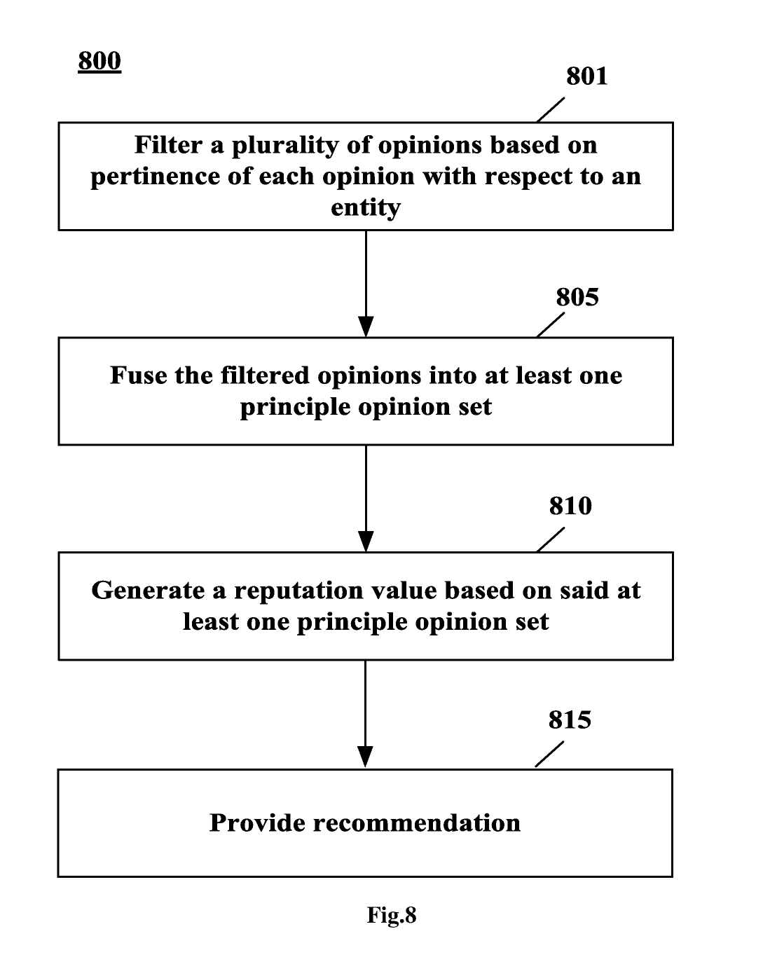

FIG. 8 is a flow chart depicting a process 800 of recommendation according to an embodiment. The steps 801, 805, and 810 in this embodiment are similar to the steps 601, 605, and 610 in FIG. 6, and the steps 701, 705, and 710 in FIG. 7 respectively. For brevity the description of these steps is omitted here. As shown in FIG. 8, in this embodiment, after generating the reputation value at step 810, the system recommends an entity based on its reputation value. For example, where there are multiple entities, the reputation value of each entity can be obtained through the steps 801 to 810. Then, the system ranks the entities according to their reputation values and recommends the entities with the highest reputation values, for example, top 10 entities.

In another embodiment, it is provided a process of recommendation to calculate an estimated rating of a user on a candidate entity, which the user has not commented, based on ratings of other users and existing opinions of that user and the other users. As explained above, similar users have similar preferences. It is possible to predict a user's rating on a candidate entity, even the user has not provided his opinion or rating on the candidate entity, or even the user has not seen that entity. This can be done by examining activities of other users who have similar tastes or preferences. Specifically, Formula (8) described above can be used to estimate a user's rating on a candidate entity. In calculating similarities, the system can use existing techniques, such as formula (1), or improved techniques, such as formula (4), as described above. After calculating the estimated ratings, multiple entities in Aₚ can be ranked according to their estimated ratings and the entities with the highest estimated ratings can be recommended.

In this embodiment, before calculating the estimated ratings, the system can filter the opinion data to exclude irrelevant opinions or spams. In this way, the accuracy of estimation can be improved. However, the step of filtering may be omitted, for example, in circumstances where the opinion data are relatively clean and do not contain many spams or irrelevant opinions.

In another embodiment, a process of opinion estimation is provided to generate an estimated opinion of a user on a candidate entity, which the user has not commented, based on existing opinions of that user and other users. As explained above, similar users have similar preferences. It is possible to predict a user's opinion on a candidate entity, even the user has not commented the candidate entity, or even the user has not seen that entity. This can be done by examining activities of other users who have similar tastes or preferences. Specifically, Formula (9) described above can be used to generate an estimated opinion of a user on a candidate entity. In calculating the similarities, the system can use existing techniques, such as formula (1), or improved techniques, such as formula (4), as described above.

Similar to the embodiment described above, in this embodiment, before calculating the estimated ratings, the system can filter the opinion data to exclude irrelevant opinions or spams. In this way, the accuracy of estimation can be improved. However, the step of filtering may be omitted, for example, in circumstances where the opinion data are relatively clean and do not contain many spams or irrelevant opinions.

In another embodiment, a process of recommendation is provided to recommend an entity, which a user has not commented, based on the sentiment of the most similar users of the user on the entity. As explained above, similar users have similar preferences. It is possible to predict a user's preference on a candidate entity, even the user has not commented the candidate entity, or even the user has not seen that entity. This can be done by examining activities of other users who have similar tastes or preferences. The process first uses Formula (10) described above to calculate the similarity between the target user u₀ and each of the other users u₁, . . . , uₙ. After obtaining the similarities, the users u₁, . . . , uₙ are ranked according to their similarities with respect to the user u₀. Thus, the process can find out the most similar user(s). Finally the process recommends one or more entities, which the user u₀ has not commented, based on the sentiment of the most similar user(s). For example, the process can recommend to the user u₀ an entity that is “liked” or “disliked” by the most similar user(s).

Similar to the embodiments described above, in this embodiment, before calculating the estimated ratings, the system can filter the opinion data to exclude irrelevant opinions or spams. In this way, the accuracy of estimation can be improved. However, the step of filtering may be omitted, for example, in circumstances where the opinion data are relatively clean and do not contain many spams or irrelevant opinions.

It will be appreciated that the above-described embodiments and their components can be combined in various manners. For example, in an embodiment, any of the above-described recommendations can be combined together to provide recommendation results, for example, based on reputation value, similarity of opinions, ratings and/or sentiment, as described above. Further, the recommendations and their combinations can also be incorporated into the process of reputation generation.

According to an aspect of the disclosure it is provided an apparatus for reputation generation of an entity from a plurality of opinions associated with that entity, wherein the entity and the plurality of opinions are expressed in a natural language, comprising means configured to carry out the methods described above. In an embodiment, the apparatus comprises means configured to filter a plurality of opinions based on pertinence of each opinion with respect to the entity; means configured to fuse the filtered opinions into at least one principle opinion set; and means configured to generate a reputation value based on said at least one principle opinion set.

The apparatus can further comprise means configured to calculate the pertinence of each opinion based on similarity between the opinion and the entity, and correlation among said plurality of opinions, and means configured to filter out an opinion whose pertinence is less than a first threshold.

According to an embodiment, the similarity is calculated with vector space model taking into consideration at least one of the factors including importance of a term in the expression and semantic similarity between terms.

According to embodiment, the apparatus further comprises means configured to calculate similarity between the filtered opinions and means configured to fuse two opinions into a principle opinion set if the similarity between the two opinions is greater than a second threshold.

According to an embodiment, the similarity is calculated with vector space model taking into consideration at least one of the factors including importance of a term in the expression and semantic similarity between terms.

According to an embodiment, the two opinions comprise a first opinion and a second opinion voting the first opinion; and the similarity between the two opinions is set to a first similarity value.

According to an embodiment, the two opinions comprise a first opinion and a second opinion citing the first opinion; and the similarity between the two opinions is set to a second similarity value.

According to an embodiment, the method further comprises means configured to generate the reputation value based on the number of opinions in each principle opinion set, its opinion set average similarity and its average rating value.

According to an embodiment, the apparatus further comprises means configured to set a rating for an opinion that fails to provide a rating on the associated entity.

In an embodiment, the apparatus further comprises means configured to visualize the opinions and the entity's reputation by reference to the at least one principle opinion set.

In an embodiment, the apparatus further comprises means configured to recommend the entity based on its reputation value.

In an embodiment, the apparatus further comprises means configured to calculate an estimated rating of a user on a candidate entity, which the user has not commented, based on ratings of other users and existing opinions of that user and the other users; and means configured to recommend the entity based on the estimated rating.

In an embodiment, the apparatus further comprises means configured to calculate an estimated opinion of a user on a candidate entity, which the user has not commented, based on opinions of other users and existing opinions of that user and the other users.

In an embodiment, the apparatus further comprises means configured to recommend an entity, which a user has not commented, based on the sentiment of the most similar users of the user on the entity.

It is noted that any of the components of the system 100, 200, 300, 400, and 500 depicted in FIG. 1-5 can be implemented as hardware or software modules. In the case of software modules, they can be embodied on a tangible computer-readable recordable storage medium. All of the software modules (or any subset thereof) can be on the same medium, or each can be on a different medium, for example. The software modules can run, for example, on a hardware processor. The method steps can then be carried out using the distinct software modules, as described above, executing on a hardware processor.

Additionally, an aspect of the disclosure can make use of software running on a general purpose computer or workstation. Such an implementation might employ, for example, a processor, a memory, and an input/output interface formed, for example, by a display and a keyboard. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. The processor, memory, and input/output interface such as display and keyboard can be interconnected, for example, via bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with media.

Accordingly, computer software including instructions or code for performing the methodologies of the disclosure, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

As noted, aspects of the disclosure may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the disclosure may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

The flowchart and block diagrams in the figures illustrate the architecture, functionality, and operation of possible implementations of systems, methods and computer program products according to various embodiments of the disclosure. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In any case, it should be understood that the components illustrated in this disclosure may be implemented in various forms of hardware, software, or combinations thereof, for example, application specific integrated circuit(s) (ASICS), functional circuitry, an appropriately programmed general purpose digital computer with associated memory, and the like. Given the teachings of the disclosure provided herein, one of ordinary skill in the related art will be able to contemplate other implementations of the components of the disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1-33. (canceled)

34. A method for generating reputation of an entity from a plurality of opinions associated with that entity, wherein the entity and the plurality of opinions are expressed in a natural language, said method comprising:
filtering said plurality of opinions based on pertinence of each opinion with respect to the entity;
fusing the filtered opinions into at least one principle opinion set; and
generating a reputation value based on said at least one principle opinion set.

35. The method according to claim 34, wherein the step of filtering comprises:
calculating the pertinence of each opinion based on similarity between the opinion and the entity, and correlation among said plurality of opinions; and
filtering out an opinion whose pertinence is less than a first threshold.

36. The method according to claim 35, wherein the similarity is calculated taking into consideration at least one of the factors including importance of a term in the expression and semantic similarity between terms.

37. The method according to claim 34, wherein the step of fusing comprises:
calculating similarity between the filtered opinions; and
fusing the filtered opinions into at least one principle opinion set if the similarity between the filtered opinions is greater than a second threshold.

38. The method according to claim 37, wherein the similarity is calculated with vector space model taking into consideration at least one of the factors including importance of a term in the expression and semantic similarity between terms.

39. The method according to claim 38, wherein two opinions comprise a first opinion and a second opinion voting the first opinion; and the similarity between the two opinions is set to a first similarity value.

40. An apparatus for generating reputation of an entity from a plurality of opinions associated with that entity, wherein the entity and the plurality of opinions are expressed in a natural language, said system comprising:
a filter configured to filter said plurality of opinions based on pertinence of each opinion with respect to the entity;
a fuser configured to fuse the filtered opinions into at least one principle opinion set; and
a reputation generator configured to generate a reputation value based on said at least one principle opinion set.

41. The apparatus according to claim 40, wherein the filter is further configured to:
calculate the pertinence of each opinion based on similarity between the opinion and the entity, and correlation among said plurality of opinions; and
filter out an opinion whose pertinence is less than a first threshold.

42. The apparatus according to claim 41, wherein the similarity is calculated with vector space model taking into consideration at least one of the factors including importance of a term in the expression and semantic similarity between terms.

43. The apparatus according to claim 40, wherein the fuser is further configured to calculate similarity between the filtered opinions, and fuse the filtered opinions into at least one principle opinion set if the similarity between the filtered opinions is greater than a second threshold.

44. The apparatus according to claim 43, wherein the similarity is calculated taking into consideration at least one of the factors including importance of a term in the expression and semantic similarity between terms.

45. The apparatus according to claim 44, wherein two opinions comprise a first opinion and a second opinion voting the first opinion; and the similarity between the two opinions is set to a first similarity value.

46. The apparatus according to claim 44, wherein two opinions comprise a first opinion and a second opinion citing the first opinion; and the similarity between the two opinions is set to a second similarity value.

47. The apparatus according to claim 40, wherein the reputation generator is further configured to generate the reputation value based on the number of opinions in each principle opinion set, its opinion set average similarity and its average rating value.

48. The apparatus according to claim 47, further comprising:
a first rater configured to set a rating for an opinion that fails to provide a rating on the associated entity.

49. The apparatus according to claim 40, further comprising:
a visualizer configured to visualize the opinions and the entity's reputation by reference to the at least one principle opinion set.

50. The apparatus according to claim 40, further comprising:
a first recommender configured to recommend an entity based on its reputation value.

51. The apparatus according to claim 40, further comprising:
a second recommender configured to calculate an estimated rating of a user on a candidate entity, which the user has not commented, based on ratings of other users and existing opinions of that user and the other users, and to recommend the candidate entity based on the estimated rating.

52. The apparatus according to claim 40, further comprising:
an opinion estimator configured to generate an estimated opinion of a user on a candidate entity, which the user has not commented, based on opinions of other users and existing opinions of that user.

53. The apparatus according to claim 40, further comprising:
a third recommender configured to recommend an entity, which a first user has not commented, based on a second user's sentiment on the entity, wherein the first and second users have similar opinions on other entities.
